(19) United States
(12) Patent Application Publication
(10) Pub. No.: US 2009/0306946 A1
(43) Pub. Date: Dec. 10, 2009

(54) METHODS AND SYSTEMS FOR SIMULATION AND REPRESENTATION OF AGENTS IN A HIGH-DENSITY AUTONOMOUS CROWD

(76) Inventors: Norman I Badler, Haverford, PA (US); Nuria Pelechano-Gomez, Valencia (ES); Jan Allbeck, Glenolden, PA (US)

Correspondence Address: Pearl Cohen Zedek Latzer, LLP, 1500 Broadway, 12th Floor, New York, NY, 10036, US

(21) Appl. No.: 12/419,952

(22) Filed: Apr. 7, 2009

Related U.S. Application Data
(60) Provisional application No. 61/071,004, filed on Apr. 8, 2008.

(51) Int. Cl. G06F 17/10; G06G 7/48

(52) U.S. Cl. 703/2; 703/6

(57) ABSTRACT

This invention relates to methods and systems for simulation and representation of the behavior of individuals in a high-density autonomous crowd in response to a changing dynamic environment.

### CROSS REFERENCE TO RELATED APPLICATIONS

This application claims priority of U.S. Ser. No. 61/071,004, filed on Apr. 8, 2008, which is incorporated in their entirety herein by reference.

### GOVERNMENT INTEREST

This research was supported by the National Science Foundation grant IIS-0200983, Office of Naval Research Virtual Technologies and Environments grant N0001 4-04-1-0259, Army Research Office grant N61339-05-C-0081. The government may have certain rights in the invention.

### FIELD OF INVENTION

This invention is directed to methods and systems for simulation and representation of the behavior of individuals in a high-density autonomous crowd in response to a changing dynamic environment.

### BACKGROUND OF THE INVENTION

Animating motion for large crowds has been an important goal in the computer graphics, movie and video games communities. There has been a considerable effort on locomotion, path planning, navigation in large virtual environments, and realistic behavior simulation using cognitive models.

Crowd agent motions are classified by three main approaches: social forces models, rule based models and cellular automata models. Although much effort has gone into improving the behavioral realism of each of these approaches, none of the current models can realistically animate high-density crowds. Social forces models tend to create simulations that look more like particle animation than human movement. Cellular automata models limit agent spatial movements and tend to expose the underlying checkerboard of cells when crowd density is high. Finally, rule based models either don't consider collision detection and repulsion at all or adopt very conservative approaches through the use of waiting rules, which work fine for low densities in everyday life simulation, but lack realism for high-density or panic situations.

Many crowd simulation methods derive from Helbing's empirical Social Forces model, which applies repulsion and tangential forces to simulate interactions between people and obstacles, realistic ‘pushing’ behaviors and variable flow rates. The main disadvantage of this approach is that agents appear to ‘shake’ or ‘vibrate’ unnaturally in high-density crowds. There has been much work done using particle simulation approaches for low-density crowds. Particle systems and dynamics have been used for modeling the motion of groups with significant physics. Individualism has been used to extend the social forces model. Some recent work has focused on extending Helbing's model but has resulted in equations that are not applicable in real-time simulations. Crowd simulation systems have been described based on continuum dynamics instead of agent rules and run at interactive rates.

Rule-based models achieve more realistic human movement for low and medium density crowds, but cannot handle contact between individuals and therefore fail to simulate ‘pushing’ behavior. These models usually adopt a conservative approach by avoiding contact and, when densities are high, applying ‘wait’ rules to enforce ordered crowd behavior without the need to calculate collision detection and response. Cognitive models have been used in combination with rule-based models to achieve more realistic behaviors for pedestrian simulation. Different behavioral rules can be applied to the crowd, group or individuals to achieve more believable overall crowd behavior.

Cellular-automata models are fast and simple to implement, but do not allow for contact between agents. Floor space is discretized and individuals can only move when the adjacent cell is free. Higher-level behaviors can be incorporated by pre-computing paths towards high-level goals and storing them within the grid.

Therefore, in order to navigate a complex environment, there is a need to have some high-level representation of the environment and the movement of many individuals (agents) in this environment.

### SUMMARY OF THE INVENTION

In one embodiment, the invention provides a method for displaying behavior of a high density autonomous crowd in a dynamic environment on a display, comprising the steps of: displaying a representation of a predetermined environment; indicating a relative position of each of a plurality of autonomous agents on the representation of the predetermined environment; assigning a dynamically changeable psychological and behavior characteristic, or both, to each of said plurality of autonomous agents; and simulating changes on said representation, representing the behavior of a plurality of the autonomous agents in the high density autonomous crowd on the representation of the predetermined environment being displayed.

In another embodiment, the invention provides a system for simulating individual agents in a high density autonomous crowd, comprising: a graphic processing module enabling representation of simulation of individual agents in the high density autonomous crowd; and an analyzing module capable of modeling motion of an autonomous agent in the high density autonomous crowd.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will be better understood from a reading of the following detailed description taken in conjunction with the drawings in which like reference designators are used to designate like elements, and in which:

FIG. 1 shows current models framework and this approach for low-level motion (HiDAC);

FIG. 2 shows the architecture overview for HiDAC agent behaviors.

FIG. 3 shows perception for the yellow agent;

FIG. 4 shows the collision avoidance rectangle of influence for an agent;

FIG. 5 shows: Bi-directional flows. People with blonde hair walk towards the left, while dark-haired people walk towards the right. (a) low-density flows, (b) high-density without altering the viewing rectangle and right preference, (c) high-density with HiDAC;

FIG. 6 shows an example of repulsion forces which are necessary to apply braking forces;

FIG. 7 shows an area of influence for waiting behaviors;

FIG. 8 shows examples of wide and thin queues emerging when animating a “normal” scenario;

FIG. 9 shows an embodiment of pushing forces;

FIG. 10 shows red-headed people exhibit panic behavior and push others to open their way through the crowd;

FIG. 11 shows agents avoiding a fallen agent in the simulation;

FIG. 12 shows impatient people avoiding bottlenecks;

FIG. 13 shows interaction with dynamic changes in the environment. Agents react to doors being closed and opened during the simulation;

FIG. 14 shows the 2D and 3D view of a high density crowd;

FIG. 15 is a block diagram representing an exemplary non-limiting general computing system or operating environment in which the present invention may be implemented;

FIG. 16 illustrates a system for displaying behavior of a high density autonomous crowd in a environment on a display, according to an embodiment of the invention; and

FIG. 17 illustrates a method for displaying behavior of a high density autonomous crowd in an environment on a display, according to an embodiment of the invention.

### DETAILED DESCRIPTION OF THE INVENTION

This invention relates in one embodiment to methods and systems for simulation and representation of the behavior of individuals in a high-density autonomous crowd in response to a changing dynamic environment.

In one embodiment, the HiDAC model used and represented in the systems and methods described herein, is tuned to simulate and display different types of crowds, ranging from extreme panic situations (fire evacuation) to high-density crowds under calm conditions (leaving a cinema after a movie). In another embodiment, allowance is made for heterogeneous crowds where a number of different behaviors can be exhibited simultaneously.

A method for displaying behavior of a high density autonomous crowd in a environment on a display is provided, the method includes: simulating a behavior of a plurality of the autonomous agents of the high density autonomous crowd in a representation of the dynamic environment; wherein the simulating is responsive to at least one characteristic of a each autonomous agent of a plurality of autonomous agents of the high density autonomous crowd; wherein the at least one characteristic is selected from a group consisting of a physiological characteristic and a behavior characteristic; and displaying the plurality of autonomous agents in the dynamic environment. In one embodiment, the agent characteristic or characteristics may be dynamically changed during the simulation.

The predetermined environment can be a dynamically changing virtual environment.

The method can include simulating changes on a dynamically changing virtual environment that comprises at least one of building stairwells, doors, windows, obstacles, stadium exits or entrances, theaters exits, theaters entrances, streets, floor plans, airplane doors.

The method can include simulating changes on the environment dynamically changes doors, entrances or exits between open and closed, or hazards blocking paths or their combination.

The method can include a stage of indicating a relative position of each of a plurality of autonomous agents, which is preceded by a stage of assembling said high density autonomous crowd.

The high density autonomous crowd can include at least four autonomous agents per square meter of predetermined environment.

The behavior can include at least one out of line forming, panic onset, navigation, locomotion, communication between agents, decision-making, collision avoidance, pushing, impatience, training, learning features of the environment, leadership, orientation skills.

The simulating can include applying a parameterized social forces model.

The method can include simulating a behavior of each autonomous agent in response to at least one predetermined psychological model variable.

The method can include performing at least one out of a high level behaviors and at least one out of low level behaviors.

At least one of the high level behavior and the low level behavior can be driven by a psychological model.

The high level behavior simulating can include simulating at least one of navigation, learning, communication between agents, and decision-making.

The low level behavior simulating can include simulating at least one out of collision avoidance, locomotion in bounded space, perception, speeds, personal space, densities, angles, reactive behaviors for collision detection, avoidance and response.

The method can include performing high level behavior simulation in response to a psychological state variable and an agent personality.

The psychological state variable can include at least one out of panic, impatience, leader versus follower, trained versus untrained, communication, probability of suffering panic, current state of panic, probability of propagating panic, probability of falling, pushing thresholds, right preference, and avoidance intensity. In one embodiment, the selected psychological or behavior characteristic may be changed during the simulating.

The method can include performing low level behavior simulation in response to a variable affected by changes in the psychological state.

The method can include performing low level behavior simulation in response to at least one of speed, fall probability, pushing thresholds, orientation skills, queuing behavior, impatience, avoidance behavior.

The method can include adjusting autonomous agent locomotion in a bounded space in response to a plurality of predetermined factors.

The factor affecting autonomous locomotion in bounded space can be distance, areas of influence, relative angles, relative directions, perceived density or their combination.

The method includes simulating dynamic changes in the environment comprise that comprise at least one out of locking/unlocking entrances or exits, bottlenecks and hazards blocking paths.

The method can include displaying results of the simulation on a display.

The simulating can be responsive to an applying of at least one stopping rule to forces that affect a movement of an autonomous agent.

The simulating can be responsive to an applying of at least one stopping rule to forces that affect a movement of an autonomous agent by setting a period between consecutive simulated movements of the autonomous agent.

The simulating can be responsive to an applying of at least one stopping rule to forces that affect a movement of an autonomous agent by setting a random period between consecutive simulated movements of the autonomous agent.

The method can include defining an influence region for an autonomous agent.

The method can include triggering a waiting behavior in an autonomous agent in response to the influence region.

The method can include defining a variable length influence region for an autonomous agent.

The simulating can include simulating a collision response of an autonomous agent in response to at least one personal space threshold.

The simulating can include applying a tangential force for obstacle avoidance without applying a repulsion force.

The simulating can include modifying a behavior of an autonomous agent in response to a personality of the autonomous agent and a perception of a level of panic of at least one other autonomous agent.

The simulating can include simulating an impatient crowd by dynamically modifying route selection in response to at least one environmental change.

The method can include simulating a movement of an autonomous agent in response to a desired attractor, while avoiding walls, obstacles and other autonomous agents while and trying to keep a previous direction of movement of the autonomous agent to avoid abrupt changes in its trajectory.

The method can include simulating a movement of an autonomous agent in response to forces representing a desired attractor, walls, obstacles, other autonomous agents, previous direction of movement and weights assigned to the forces; wherein at least one weight is determined by at least one rule out of a psychological rule and a geometrical rule.

The simulating can include exchanging information between a high level behavior module and a low level behavior module.

The simulating can include receiving, by a high level behavior module, information about at least one of a bottleneck and a door change perceived by an autonomous agent; deciding by the high level behavior module, next attractor and send next attractor information to a low level behavior module.

The method can include indicating a relative position of each of a plurality of autonomous agents on the representation of the predetermined environment

A system for displaying behavior of a high density autonomous crowd in a environment on a display, the system includes: an analyzing module capable of simulating a behavior of a plurality of the autonomous agents of the high density autonomous crowd in a representation of the dynamic environment; wherein the simulating is responsive to at least one characteristic of a each autonomous agent of a plurality of autonomous agents of the high density autonomous crowd; wherein the at least one characteristic is selected from a group consisting of a physiological characteristic and a behavior characteristic; and a hardware graphic processing module capable of displaying the plurality of autonomous agents in the dynamic environment.

A system for simulating individual agents in a high density autonomous crowd, the method includes: a hardware graphic processing module enabling representation of simulation of individual agents in the high density autonomous crowd; and an analyzing module capable of modeling motion of an autonomous agent in the high density autonomous crowd.

Either one of the mentioned above systems is capable of implementing the method mentioned above or any combination of its stages.

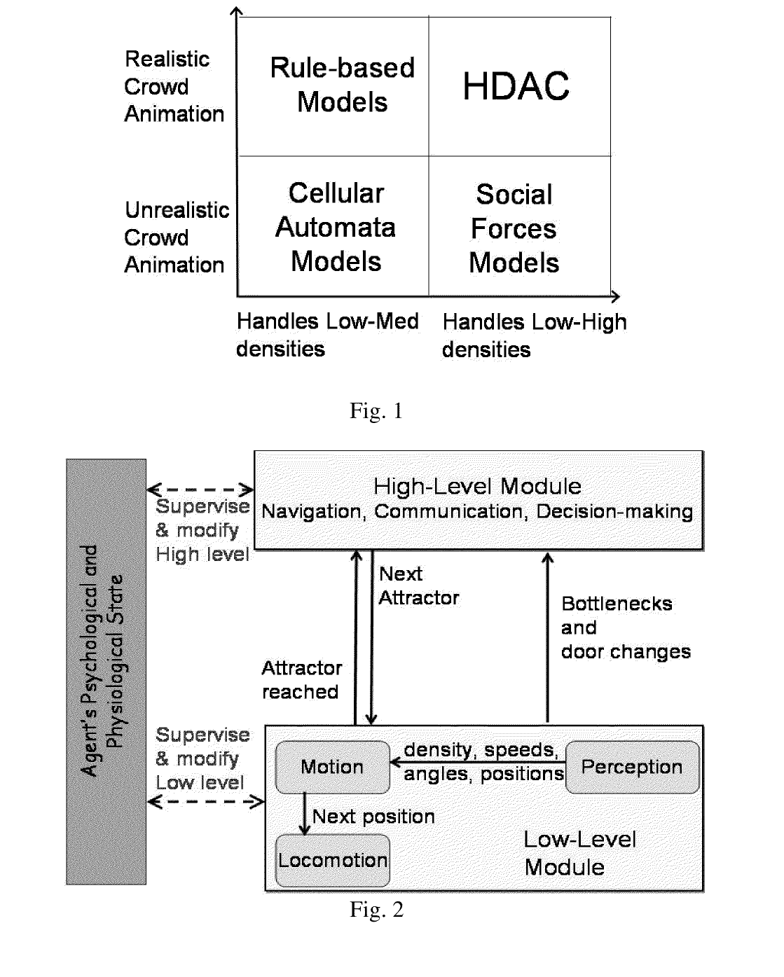

In one embodiment, a taxonomy for crowd simulation is shown in FIG. 1, which compares the model described herein and used in the methods and systems provided (HiDAC: High-Density Autonomous Crowds) with the main models in the literature along the dimensions of animation realism and crowd density.

In another embodiment, the HiDAC described herein addresses the problem of simulating high-density crowds of autonomous agents moving in a natural manner in dynamically changing virtual environments. In one embodiment, the problem of realistically simulating local motion under different situations and agent personalities is addressed using psychological, physiological and geometrical rules combined with physical forces. Since applying the same rules to all agents leads to homogeneous behavior, in another embodiment, agents are given different psychological (e.g., impatience, panic, personality attributes) and physiological (e.g., locomotion, energy level) traits that trigger individual heterogeneous behaviors. In one embodiment, each agent is also endowed with perception and reacts to static and dynamic objects and other agents within the nearby space.

Unlike cellular automata and rule-based models, in another embodiment the HiDAC model used and represented in the systems and methods described herein realistically simulate and display an individual trying to force its way through a crowd by pushing others, and unlike social forces models, the agents displayed using the methods and systems described herein, exhibit a more respectful behavior when desired and make decisions in terms of letting others walk first and queuing when necessary. These emergent behaviors are driven in certain embodiments, by the combination of psychological and physiological rules together with a social forces model. In one embodiment, “Impatience” is integrated in order to avoid the sheep-like behavior that many crowd simulation models exhibit.

Accordingly and in one embodiment, provided herein is a method for displaying behavior of a high density autonomous crowd in a dynamic environment on a display, comprising the steps of: displaying a representation of a predetermined environment; indicating a relative position of each of a plurality of autonomous agents on the representation of the predetermined environment; assigning a psychological and behavior characteristic, or both, to each of said plurality of autonomous agents; and simulating changes on said representation, representing the behavior of a plurality of the autonomous agents in the high density autonomous crowd on the representation of the predetermined environment being displayed. In another embodiment, the method provides dynamically changing agent characteristics during simulating.

In one embodiment, the dynamic environment used for the simulation in the systems and methods described herein is a dynamically changing virtual environment, such as an environment capable of representing building stairwells, or stadium exits or entrances, theaters exits or entrances, streets, floor plans, airplane doors and the like in other discrete embodiments of the dynamically changing virtual environment.

In another embodiment, the step of indicating a relative position of each of a plurality of autonomous agents is preceded by a step of assembling said high density autonomous crowd. In one embodiment, the term “High Density Autonomous Crowd” or “HiDAC” refers to a crowd density of no less than 4 people per M².

Realistic movement may be defined in one embodiment, as the emergence of crowd behaviors consistent with real observed crowds, and appropriate individual collision avoidance and collision response. Such realism is obtained in the methods and systems described herein, through contextual application of physical and geometric algorithms. In one embodiment, over longer distances tangential forces gently steer agents around obstacles, while over shorter distances collision response is applied in another embodiment, to avoid overlapping. Pushing behavior between agents arises from varying the long/short personal space threshold of each individual. Agents in a hurry will not respect others' personal space and will appear to push their way through the crowd. In contrast, more ‘polite’ agents will respect lines and wait for others to move first.

In one embodiment, local crowd density is not homogeneous. In another embodiment, at average densities of 6 persons per m², the local density is up to 9 per m². In one embodiment, at high densities, agents keep moving. In one embodiment, when local crowd density increased above a given threshold, e.g. at local densities ≧7 per m² in another embodiment, a collective crowd motion exists. In these circumstances individual control is partially lost, when agent's bodies are pressed against each other. In certain embodiments, the collective crowd locomotion creates an increase of the flow, which in certain embodiments, cause forward and backward compression waves. In one embodiment, the systems and methods described herein are able to simulate, represent and display the behavior of such a crowd and the threshold at which the autonomous agent loses its autonomy becomes a variable of the environment.

In one embodiment, each agent has an influence disk (region) in front of it that triggers waiting behavior. For example, relaxed agents temporarily stop when another agent moves into their path, while impatient agents do not respond to this feedback and tend to ‘push’. The system described herein prevents stops impatient agents from appearing to ‘vibrate’ as they try to force their way through dense crowds. Instead, temporal stopping states are added in order to prevent the agent from trying to move during a short interval of time, although it can still be pushed by others.

In one embodiment, the behavior simulated using the systems and methods described herein is line forming, or panic onset, navigation, locomotion, communication between agents, decision-making, collision avoidance and the like or their combination in other discrete embodiments. In another embodiment, each agent in the HiDAC has its own behavior based on a predetermined personality variable, or in another embodiment, a plurality of variables. In another embodiment, panic propagation is a function of nearest neighbors pushing and an initially non-panicked agent may become panicked as the result of the change in behavior of its neighbors.

In one embodiment, the autonomous agent behavior represented using the simulation methods and systems described herein is a high level behavior, or a low level behavior or their combination in other discrete embodiment. In one embodiment, high level behavior comprises navigation in complex virtual environments, learning, communication between agents, decision-making and the like or their combination in other discrete embodiment of the high level behavior of the autonomous agent described herein. In another embodiment, low level behavior, or motion controllers, comprises collision avoidance or locomotion in bounded space and the like or their combination in other discrete embodiment of the low level behavior of the autonomous agent described herein.

In one embodiment, high level behavior of the autonomous agent described herein is affected by a psychological state variable such as panic, or impatience, personal space comfort and the like or their combination in other discrete embodiments. In one embodiment, low level behavior is affected by another variable, which is affected by the psychological state described herein, such as speed in one embodiment, or fall probability, pushing thresholds, and the like or their combination in other discrete embodiments of the variable affected by changes in the psychological states described herein.

In one embodiment, the autonomous agent locomotion in bounded space represented using the simulation methods and systems described herein is adjusted to a plurality of predetermined factors, such as distance in one embodiment, or areas of influence, relative angles and the like or their combination in other embodiments.

In one embodiment, the dynamic changes in the environment used to trigger the changes in HiDAC agents behavior represented using the simulation methods and systems described herein, comprise queuing behavior, or pushing, panic, natural disaster onset, artificial disaster onset and the like or their combination in other discrete embodiments.

In one embodiment, provided herein are novel extensions to social forces models by adding stopping rules and influence region controls that mitigate agent vibration while not increasing computational time. The system and methods described herein, uses the best features of both rule-based and social forces systems, while eliminating their disadvantages. Implementation of the systems described herein, allow in one embodiment real-time simulations for hundreds of individualized agents. The social force model extensions mitigates in another embodiment, combinatorial problems associated with the possible geometric arrangements of large numbers of agents. Rather than analyze all possible spatial configurations or force agents into discrete cells, the HiDAC model used and displayed in the systems and methods described herein uses general behaviors based on surrounding social forces and crowd density perception to limit influences and consequences to a small number of nearby agents.

In one embodiment, the methods described herein are used in the systems provided herein. Accordingly and in another embodiment, provided herein is a system for simulating individual agents in a high density autonomous crowd, comprising: a graphic processing module enabling representation of simulation of individual agents in the high density autonomous crowd; and an analyzing module capable of modeling motion of an autonomous agent in the high density autonomous crowd.

HiDAC refers in one embodiment to a multi-agent system without a centralized controller. In another embodiment, each agent has its own behavior based on personality variables that represent physiological and psychological factors observed in real people. Agent behaviors are computed using the systems described herein at two levels:
a) High-level behavior: comprising navigation, learning, communication between agents, and decision-making and the like or their combination; and
b) Low-level motion: comprising perception and a set of reactive behaviors for collision avoidance, detection and response in order to move within a bounded space.

An embodiment of the interaction between the two levels is shown in FIG. 2. In one embodiment, the High-Level module receives information about bottlenecks and door changes that have been perceived by the agent and makes decisions based on that information and its current knowledge of the environment. Once the high-level decides the next room to walk to, it sends the next attractor point to the Low-Level module to carry out the required motion to reach it. When the Low-Level module reaches the attractor, it queries the High-Level module for the next attractor in its path towards the destination.

In another embodiment, the Motion sub-module queries the Perception sub-module about positions and angles of obstacles, crowd density ahead of the agent, and velocity of dynamic obstacles. Based on information perceived and the internal state of the agent (current behavior, panic, impatience, etc.), the Motion sub-module calculates the velocity and next position of the agent, and sends a message to the Locomotion sub-module to execute the correct feet movements.

Both high-level and low-level agent behavior are affected in certain embodiments by psychological and physiological attributes. The high-level is affected in another embodiment by changes in psychological state (e.g. panic or impatience), thus altering the decision-making process in certain embodiments. In one embodiment, agent memory and orientation abilities are also affected by psychological states.

The low level is affected in one embodiment, by changes in the agent's psychological state which in another embodiment trigger modification of its speed, fall probability, pushing thresholds, and the like or their combination in other certain discrete embodiments. In one embodiment, the psychological model has as an input, information about environment events detected by the agent's perception system and in another embodiment, information obtained through communication. This information is combined with the agent's current emotional state, modifying it in certain embodiments, provide in one embodiment updated input to both low and high-level modules.

In one embodiment, the analyzing module used in the systems described herein, is capable of modeling motion of an autonomous agent in the high density autonomous crowd; comprises an operably linked: high-level module, low level module and personality module. In one embodiment, the low level module comprises a motion sub-module, a perception sub-module and a locomotion sub-module.

In one embodiment, local agent motion is based on a combination of geometrical information and psychological rules with a forces model to enable a wide variety of behaviors resembling those of real people. In another embodiment, HiDAC uses psychological attributes (panic, impatience) and geometrical rules (distance, areas of influence, relative angles) to eliminate unrealistic artifacts and to allow new behaviors that are capable of being simulated and displayed using the systems and methods described herein. In one embodiment, these new behaviors comprise preventing agents from appearing to vibrate in one embodiment, or creating natural bi-directional flow rates, queuing and other organized behavior, pushing through a crowd, agents falling and becoming obstacles, propagating panic, exhibiting impatience, reacting in real time to changes in the environment, or their combination in other embodiments.

In one embodiment, HiDAC is a parameterized social forces model that depends on psychological and geometrical rules. High-Level module determines in one embodiment, which attractor point (e.g. waypoint in one embodiment or portal in another) an agent walks to within a room. Collision avoidance, detection and response are performed in another embodiment, only with the people in the same room, and with static elements of that room (walls and obstacles) or their combination in other embodiments. When people are crossing portals in certain embodiments, care is taken to avoid intersection between agents leaving and agents entering. In one embodiment, HiDAC keeps track of the people currently crossing a portal, so that when an agent is near a door, collision detection is performed against agents in the room and agents crossing the doorway.

Collision detection and response is performed in one embodiment with those agents that are overlapping the agent from any direction. In another embodiment, collision avoidance is only performed against individuals that appear in the desired direction of movement, and therefore are relevant to an agent's future position.

The following examples are presented in order to more fully illustrate the preferred embodiments of the invention. They should in no way be construed, however, as limiting the broad scope of the invention.

### EXAMPLES

### Methods

In certain embodiments of the invention, the movement of agent i (Fᵢ^{To}) depends on the desired attractor (Fᵢ^{At}), while avoiding walls w (F_{wi}^{Wa}), obstacles k (Fₖᵢ^{Ob}) and other agents j (Fⱼᵢ^{Ot}) and trying to keep its previous direction of movement to avoid abrupt changes in its trajectory (Fᵢ^{To}[n−1]). All these forces are summed together with different weights wᵢ that are the result of psychological and/or geometrical rules, and determine the importance of each force on the final desired direction of movement:

$${F}_{i}^{To} [ n ] = {F}_{i}^{To} [ n - 1 ] + {F}_{i}^{At} [ n ] {w}_{i}^{At} + {\sum }_{w} {F}_{wi}^{Wa} [ n ] {w}_{i}^{Wa} + {\sum }_{k} {F}_{ki}^{Ob} [ n ] {w}_{i}^{Ob} + {\sum }_{j ( \neq i )} {F}_{ji}^{Ot} [ n ] {w}_{i}^{Ot} \qquad ( 1 )$$

The force vector is therefore:

$${f}_{i}^{To} = \frac{{F}_{i}^{To}}{\vert {F}_{i}^{To} \vert} \qquad ( 2 )$$

And finally the new desired position pᵢ[n+1] for agent i is calculated as:

pᵢ[n+1]=pₙ[n]+αᵢ[n]vᵢ[n]((1−βᵢ[n])fᵢ^{To}[n]+βᵢ[n]Fᵢ^{Fa}[n])) +rᵢ[n] (3)

where:
(a) vᵢ[n] is the magnitude of the velocity in the simulation step n. The velocity at each time step is calculated as

$${v}_{i} [ n ] = \{ \begin{matrix}{v}_{i} [ n ] = {v}_{i} [ n - 1 ] + aT & if {v}_{i} [ n ] < {v}_{i}^{MAX} \\ {v}_{i}^{MAX} & otherwise\end{matrix}$$

where a is a constant that represents the acceleration of the agent when it starts walking until it reaches vᵢ^{MAX}.
(b) vᵢ^{MAX} is the agent's maximum walking velocity. It can be set to depend on agent capability (normal, handicapped) and modified dynamically if the agent enters panic mode or is injured.
(c) rᵢ is the result of the repulsion forces that affect the agent when it overlaps with a wall, obstacle or another agent, as discussed below.
(d) α represents whether the agent will move in this step in its desired direction of movement or instead be pushed by a repulsion force

$${α}_{i} = \{ \begin{matrix}0 & if \vert {r}_{i} \vert > 0 ⋁ StoppingRule ⋁ WaitingRule \\ 1 & otherwise\end{matrix}$$

The StoppingRule and WaitingRule are used to avoid shaking behavior and to allow for line formation, respectively.
(e) βᵢ is used to give priority to avoiding fallen agents on the floor:

$${β}_{i} = \{ \begin{matrix}0.5 & if distance to fallen agent < 2 m \\ 0 & otherwise\end{matrix}$$

(f) Fᵢ^{Fa} is the avoidance force to avoid fallen agents, as discussed below.
(g) T is the increment in time between simulation steps.

### Example 1

### Avoidance Forces

Autonomous agents need to perceive the environment to avoid static and dynamic obstacles while walking to an attractor. HiDAC provides efficient perception through a cell and portal graph. Each cell corresponds to a room, and contains information about all the static objects within it. As the agents traverse the environment, the lists of dynamic objects within each room are rapidly updated; thus an agent can obtain obstacle data by querying the cell.

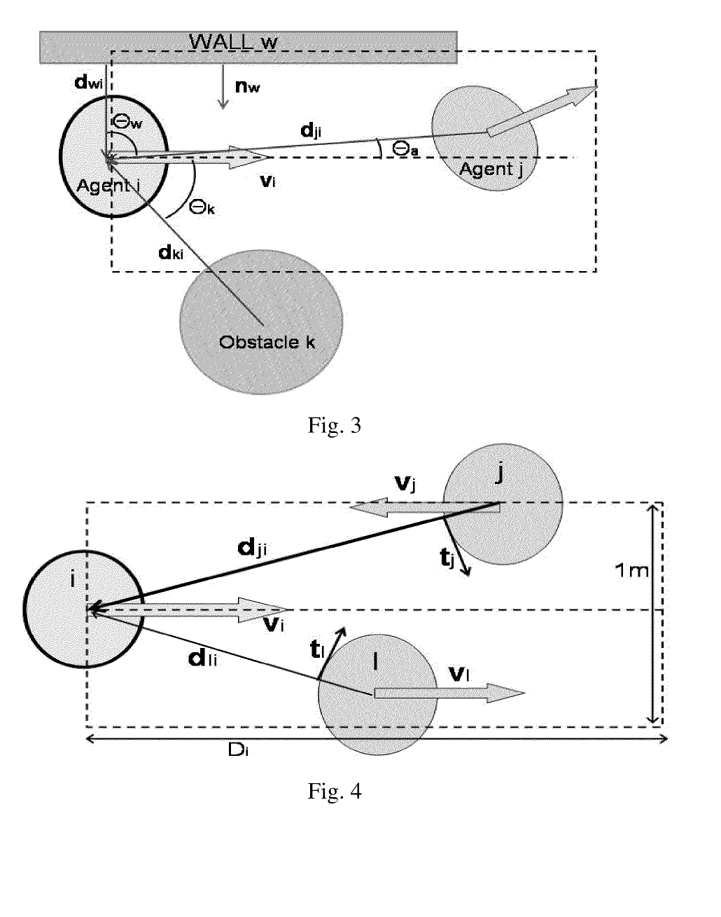

For each obstacle, wall and agent, it is necessary to calculate its distance to agent i and, if it is close enough, then we calculate the angle between agent i's desired direction and the line joining the center of agent i and the obstacle. This information is used to determine whether it falls within the rectangle of influence (FIG. 3). The distance and the angle provide enough information to establish how relevant that obstacle is to the trajectory. As they navigate the environment, agents also update their perceived density of the crowd ahead which will be necessary to their decision-making process.

### Example 2

### Wall and Obstacle Avoidance Forces

Avoidance forces are calculated only for relevant obstacles, walls and agents: those falling within the rectangle of influence. The avoidance force for obstacle k is:

$${F}_{ki}^{Ob} = \frac{( {d}_{ki} \times {v}_{i} ) \times {d}_{ki}}{\vert ( {d}_{ki} \times {v}_{i} ) \times {d}_{ki} \vert} \qquad ( 4 )$$

The avoidance force for wall w is

$${F}_{wi}^{Wa} = \frac{( {n}_{w} \times {v}_{i} ) \times {n}_{w}}{\vert ( {n}_{w} \times {v}_{i} ) \times {n}_{w} \vert} \qquad ( 5 )$$

### Example 3

### Other Agent Avoidance: Overtaking and Bi-directional Flow

To exhibit realistic counter flows and overtaking behaviors, rules are included, which modify some parameters of the forces model. This approach allows simulating human behavior by setting parameters related to real human movement. In certain embodiments, the parameters that affect the tangential forces for obstacle avoidance are: Distance to obstacles, Direction of other agents relative to agent i's desired velocity vector (vᵢ), and Density of the crowd, and the like or their combination.

If an agent appears in the rectangle of influence, then tangential forces (described below) will be applied in order to slightly modify the direction of movement and make a curve in the trajectory to avoid collision.

The angle between two agents' velocity vectors determines whether their movements are confluent or opposed. This angle is also used to simulate human decision-making of how to react to an imminent collision. In one embodiment, if agents are walking on the left side of a corridor, and another person walks towards the agents on the right, none of the agents would change direction, but if all are walking in the middle of the corridor, the majority of people have a tendency to move towards their right side. Therefore, when the velocity vectors are almost collinear, in one embodiment, the tangential forces will point to the right.

### Example 4

### Avoidance by Agent

Suppose an agent i detects agent j and agent l as possible obstacles (see FIG. 4). The distance vector towards agent i is calculated for each of the potential obstacles (dⱼᵢ and dₗᵢ). Agent j is farther away than l, but since it is moving against agent i, the perception algorithm establishes this obstacle as having higher priority. An agent to be avoided is selected in another embodiment, if it falls within the influence rectangle, unless that agent is walking in the opposite direction and with distance smaller than Dᵢ−1.5, where Dᵢ is the length of the rectangle.

The tangential force (tⱼ) that will steer agent i to avoid j is:

$${t}_{j} = \frac{( {d}_{ji} \times {v}_{i} ) \times {d}_{ji}}{\vert ( {d}_{ji} \times {v}_{i} ) \times {d}_{ji} \vert} \qquad ( 6 )$$

Next, the normalized tangential vector is multiplied by two scalar weights to obtain the final avoidance force:

Fⱼᵢ^{Ot}=tⱼwᵢ^{d}wᵢ^{o} (7)

where wᵢ^{d} is the weight due to the distance between agents, and increases as the distance between the two agents becomes smaller and thus the agent i trajectory will change more abruptly as the distance to agent j decreases:

wᵢ^{d}=(dⱼᵢ−Dᵢ)² (8)

and wᵢ^{o} is the weight due to the difference in orientation of the velocity vectors. It distinguishes whether the perceived agent is moving in the same direction as agent i or against it, and thus the magnitude will be higher to avoid counter flow.

$${w}_{i}^{o} = \{ \begin{matrix}1.2 & if ( {v}_{i} \cdot {v}_{j} ) > 0 \\ 2.4 & otherwise\end{matrix} \qquad ( 9 )$$

The last parameter to consider is the crowd density, which each agent perceives at any given time. If the crowd is very dispersed, then people look for avoidance from far away and keep their preference for the right hand side of the space (Dᵢ=3 m); but when the crowd is very dense, then the right preference is not so obvious and several bi-directional flows can emerge (Dᵢ=1.5 m). Modifying the length of the collision avoidance rectangle and reducing the angle for right preference based on perceived density achieves this behavior.

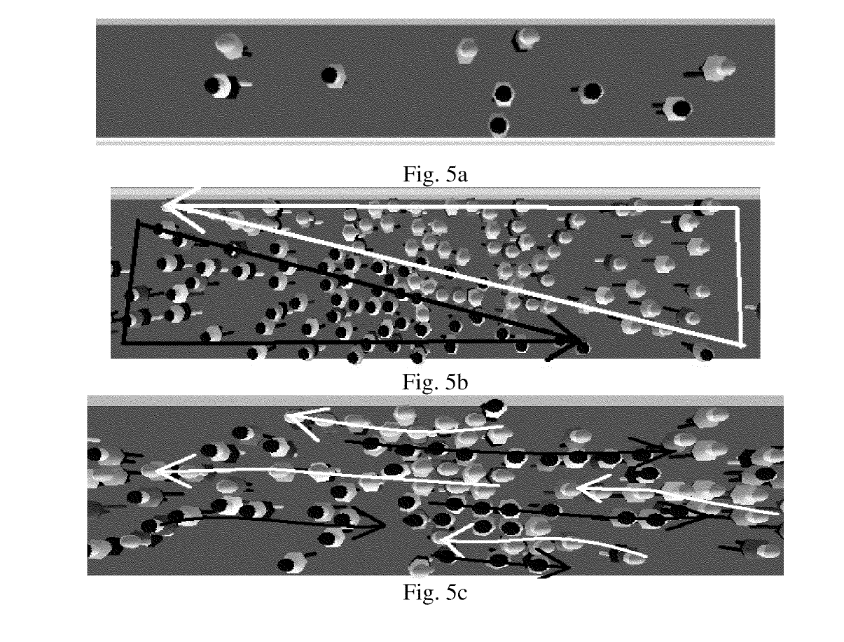

FIG. 5 shows different bi-directional flow-rate formation for low and high densities. FIG. 5b shows the result if the length of viewing rectangle and right preference parameters are not affected by density. The emergent behavior shows an unrealistic “triangle” of people moving in opposite directions, and awhile later in the simulation, two perfectly formed groups of people appear to move in opposite directions, which is less common in real high-density crowds.

In one embodiment, HiDAC produces an interesting emergent counter flow behavior for high-density crowds (see FIG. 5c): the formation of lanes of people moving in the same direction intermingled among lanes moving in the opposite direction. This is a behavior that is often observed in real crowds, and it emerges here even though it is not explicitly implemented.

### Example 5

### Repulsion Forces

When an agent's position overlaps with any static or dynamic obstacle, wall or agent then a collision response force applies. The repulsion force rᵢ from equation (3) is calculated as:

$${r}_{i} [ n ] = {\sum }_{w} {F}_{wi}^{R\_Wa} [ n ] + {\sum }_{k} {F}_{ki}^{R\_Ob} [ n ] + λ {\sum }_{j ( \neq i )} {F}_{ji}^{R\_Ot} [ n ] \qquad ( 10 )$$

where F_{wi}^{R}^{_{—}}^{Wa} is the repulsion force from wall w, Fₖᵢ^{R}^{_{—}}^{Ob} is the repulsion force from obstacle k and Fⱼᵢ^{R}^{_{—}}^{Ot} is the repulsion force from another agent j:

$$\begin{matrix}{F}_{wi}^{R\_Wa} [ n ] = \frac{{n}_{w} ( {r}_{i} + {ɛ}_{i} - {d}_{wi} [ n ] )}{{d}_{wi} [ n ]} & ( 11 ) \\ {F}_{ki}^{R\_Ob} [ n ] = \frac{( {p}_{i} [ n ] - {p}_{k} [ n ] ) ( {r}_{i} + {ɛ}_{i} + {r}_{k} - {d}_{ki} [ n ] )}{{d}_{ki} [ n ]} & ( 12 ) \\ {F}_{ji}^{R\_Ot} [ n ] = \frac{( {p}_{i} [ n ] - {p}_{j} [ n ] ) ( {r}_{i} + {ɛ}_{i} + {r}_{j} - {d}_{ji} [ n ] )}{{d}_{ji} [ n ]} & ( 13 )\end{matrix}$$

where pᵢ is the position of agent i, pⱼ is the position of agent j and pₖ is the position of obstacle k. Radii rₖ, rᵢ, and rⱼ belong to obstacle k and agents i and j, respectively. Similarly, dⱼᵢ and dₖᵢ are the distances between the centers of agent i and j, and the centers of agent i and obstacle k; d_{wi} is the shortest distance from the center of agent i to the wall w.

λ in equation 10 is used to set priorities between agents (that can be pushed) and walls or obstacles (that cannot be pushed). If there is repulsion from walls or obstacles, then λ is set to 0.3 to give preference to avoiding intersection with walls or obstacles over agents that can be pushed away. Finally εᵢ and εⱼ are small personal space thresholds that the agents have and are used for the purpose of assigning different pushing abilities based on personality.

### Example 6

### Solution to “Shaking” Problem in High-densities

When an agent encounters a bottleneck in a high-density crowd, applying a basic forces model leads to an unnatural behavior where agents appear to vibrate continuously. This behavior must be avoided. In HiDAC, “stopping rules” are incorporated. These rules are applied based on the predetermined personality of the agent, direction of movement of other agents and current situation (panic vs. normal). When repulsion forces from other agents appear against the agent's desired direction of movement, and the agent is not in panic state, then the stopping rule applies:

If ((vⱼ·Fᵢ^{R}^{_{—}}^{Ot}[n])<0) [symbol] ( [symbol] panic), then StoppingRule=TRUE

In order to avoid deadlocks, in one embodiment, a timer is set to a random value within a small range, and when the timer reaches 0, the agent will set StoppingRule=FALSE, so that in the next simulation step the agent will try to move again. When StoppingRule=TRUE, the parameter αᵢ in equation (3) is set to 0, which implies that the agent will only change position if it is pushed by other agents; otherwise it will inhibit the intention to move for several simulation steps. This effect drastically reduces the shaking behavior observed in the social force model without increasing the computational time of the algorithm.

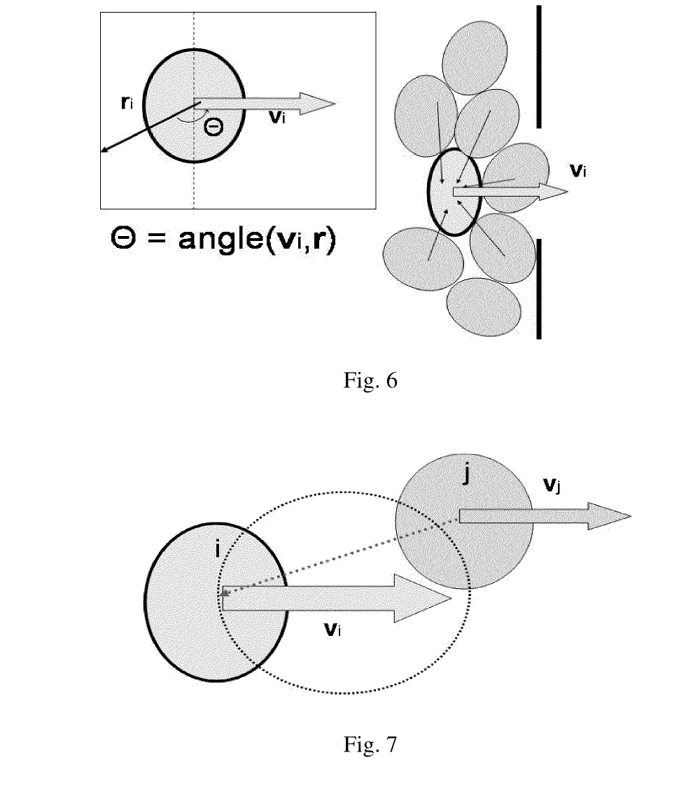

In one embodiment, only forces directed backward are relevant (see FIG. 6). If the forces appear to be towards our desired movement, we cannot decrease their intensity by not moving forward and therefore no reaction is necessary. This method succeeds in reducing shaking behavior, while still allowing body contact and thus pushing behavior. Since stopping rules do not apply when the agent is being pushed forwards, this achieves the desired emergent result of people appearing to be pushed through doorways when there is a high-density crowd behind them.

### Example 7

### Organized Behavior—queuing

In most “normal” (non-panic) situation, people will respect lines and wait for others to walk first. Such organized behavior emerges in one embodiment, by adding influence disks ahead of each agent that drive the temporal waiting behavior; they work similar to the stopping rules. FIG. 7 shows the area that triggers waiting behaviors in a non-panicked agent i in a high-density crowd when another agent j, walking in the same direction, falls within the disk: agent i sets WaitingRule=TRUE and a timer starts. Agent i moves again when its area of influence does not satisfy the conditions for waiting, or when the timer reaches the value 0 to avoid deadlocks. The radius of the influence disk depends on personality (different people tend to respect different distances) and type of behavior desired: e.g., panicking agents will not respect these distances.

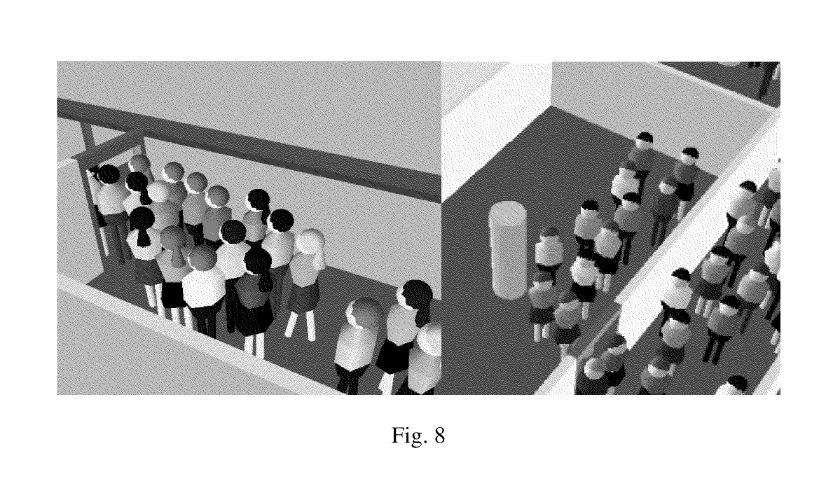

For simulations of “normal” situations (e.g., individuals leaving a cinema after a movie in another embodiment) all the agents exhibit waiting behavior when there is no available space ahead of them. The emergent behavior observed corresponds in one embodiment to queuing. Since agents use tangential forces to move within a crowd while avoiding others, the strength of those tangential forces will lead to narrow or wide queues, as can be observed in FIG. 8. The user can specify those tangential forces to be minimum, medium or maximum.

### Example 8

### Pushing Behavior

Pushing behavior emerges in one embodiment because the HiDAC model provided herein can handle not only collision avoidance but also collision detection and response. Agents have different behaviors that can be triggered at any time. During an organized situation, individuals wait for space available before moving, but when in panic, they try to move until they collide with other individuals who impede forward progress. By combining both behaviors simultaneously for a heterogeneous crowd, we observe an emergent behavior where some individuals that do not respect personal space will get very close to other agents and push them away in order to open a path through a dense crowd. The effect of being pushed away is achieved by applying collision response forces and different personal space thresholds (εᵢ and εⱼ from the repulsion equations 11, 12 and 13).

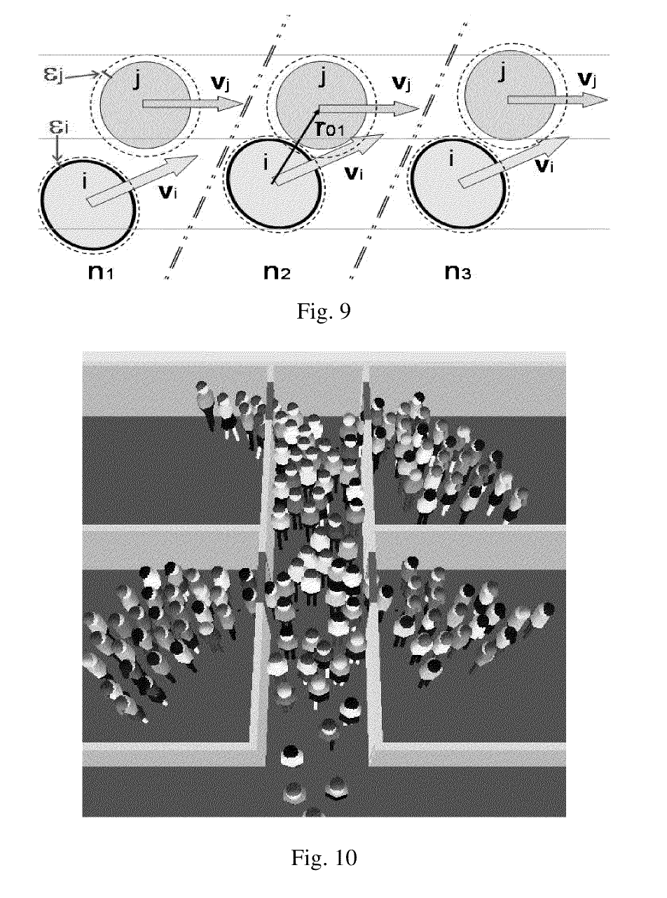

An agent suffers a repulsion force from another agent when its personal space is overlapped. FIG. 9 shows an embodiment of sequence of simulation steps represented by the methods and systems described herein, where a smaller personal space threshold εᵢ allows agent i to get closer to agent j who has a larger personal space threshold εⱼ. Thus agent i can push away agent j while agent i is not being pushed and can continue with its desired trajectory. FIG. 10 shows an embodiment where the top left room has been filled with panicked people (represented by red-heads in another embodiment), who will tend to push others away, while the other three rooms contain individuals following more organized behaviors. After a few seconds of simulation, the red-headed people have managed to almost empty their room by pushing others away in the corridor in order to reach the exit faster. Individuals in the other rooms are calmly waiting for their turn to get through the door.

### Example 9

### Falling and Becoming Obstacles

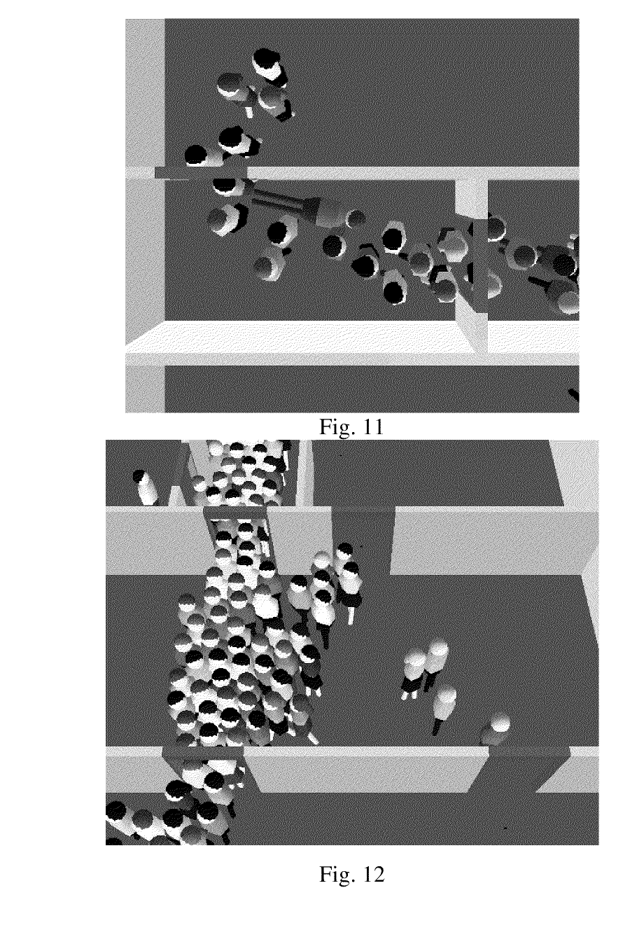

A benefit to a physical social force model is that in one embodiment it is used to gauge potential injury arising from high-density situations. When the majority of pushing forces affecting one individual are approximately in the same direction, the agent will receive a sum of forces with magnitude high enough to make it lose equilibrium. At this moment the person falls in one embodiment, and becomes an obstacle for the rest of the crowd. Fallen agents represent a different type of obstacle because, unlike walls and columns, a body on the floor is an obstacle that should be avoided, but in another embodiment, if necessary (or unavoidable) can be stepped over. In the HiDAC model described herein, fallen individuals become a rectangular obstacle (a bounding box covering the torso and head, but not the legs since other individuals can easily step over that part of the agent). When other agents approach this new obstacle, weak tangential forces are applied in order to walk around the fallen agent (Fᵢ^{Fa} in equation 3), but repulsive forces are not applied. Therefore, when the crowd is extremely dense and the pushing forces from behind are strong, the result is that agents may walk over the body on the floor, as has been observed in actual extreme situations. FIG. 11 shows an example of this behavior (where the crowd density is artificially low for visibility).

### Example 10

### Panic Propagation

In one embodiment, the HiDAC model used in the methods and systems described herein simulates an emergency evacuation. When an alarm goes off some agents will start in the panic mode. While in panic they tend to move faster, push, and exhibit agitated behavior. All these behaviors depend on the agent personality and levels of panic. As the agents start running, they may provoke panic in other agents whose behavior will be modified in turn. To propagate panic, we use either communication between agents (managed by the High-Level behavior module), or perception to detect relevant changes in low-level behaviors, such as increasing crowd densities and number of people pushing or both.

### Example 11

### Avoiding Bottlenecks and Interactive Changes in the Environment

When dealing with high-density crowds in buildings, bottlenecks appear in certain embodiments in the portals. The models described herein incorporate a high-level decision process that allows impatient agents in certain embodiments, to react to this situation by finding an alternative path. As the low-level algorithm detects the bottleneck, it sends that information to the high-level which will try to find an alternative route based on what the agent can perceive from its current position (doors, obstacles) and the knowledge that the agent has about the internal connectivity of the building. If an alternative path is available, the high-level chooses a new portal as the goal and sets an attractor point to change the direction of movement. FIG. 12 shows a bottleneck and how impatient individuals (represented by the blonde people) have sought and walked toward an alternative door.

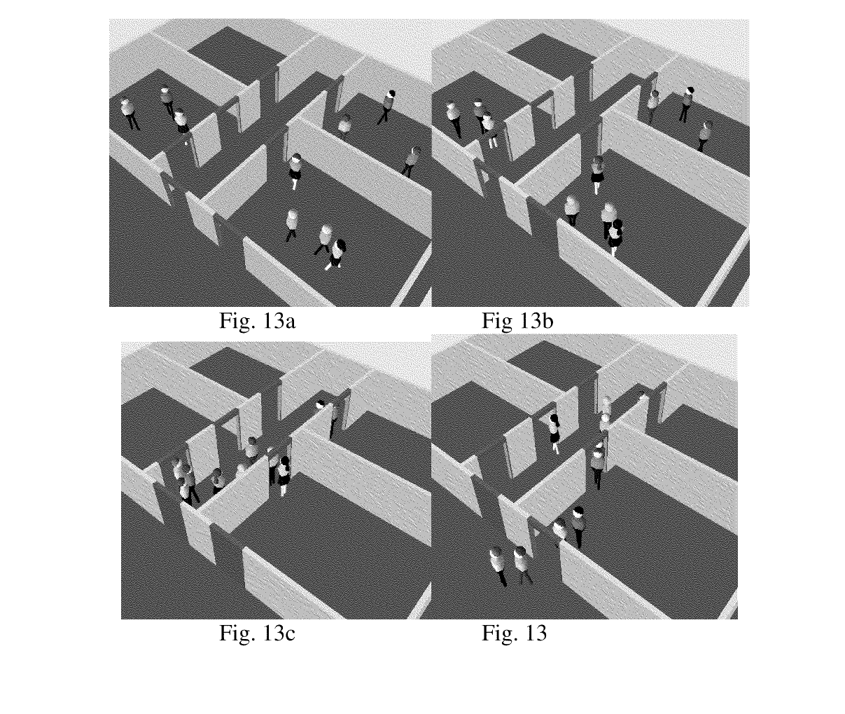

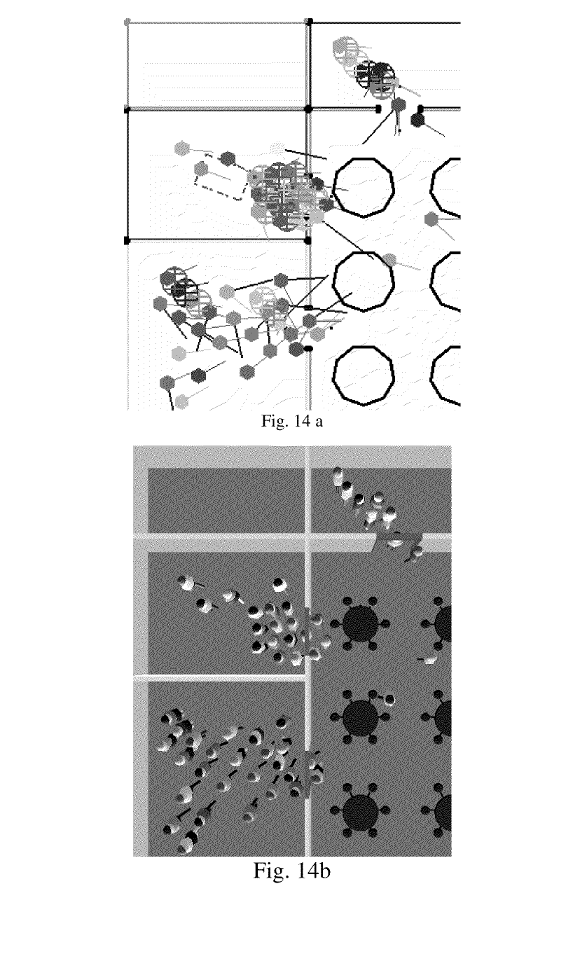

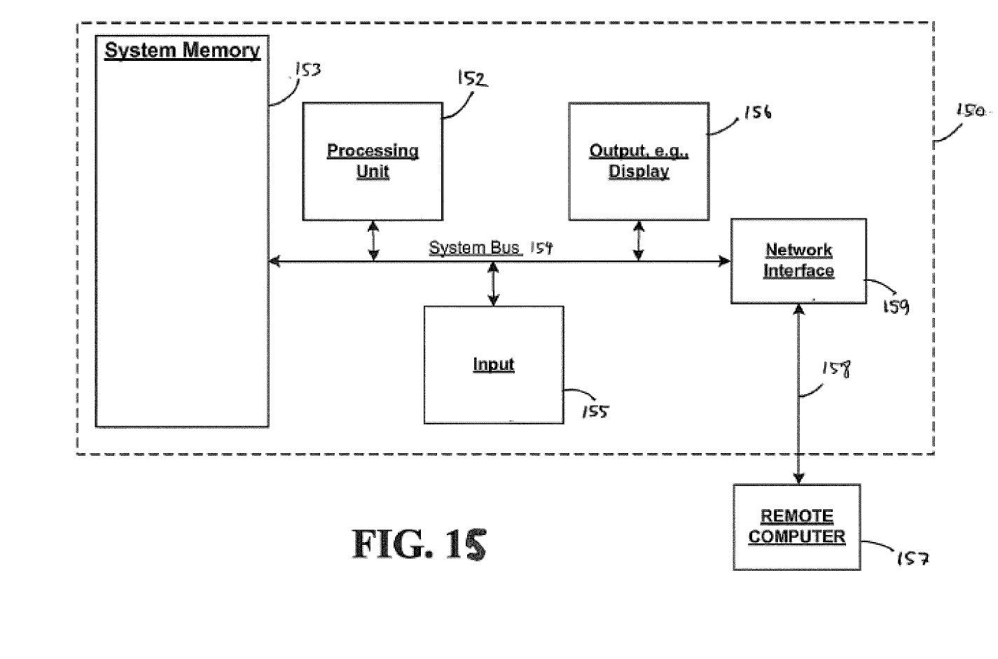

When a change occurs in the environment (e.g., a door is blocked by fire) agents perceive and react to it. For an access change, the High-Level module needs to make a new way finding decision. The agent detects this change in real time and sets its destination to the new attractor set by the High-Level. FIG. 13 shows an embodiment where dynamic way finding is forced by opening and closing doors, and agents must search for alternative paths. All low-level behaviors are still active during these activities. These examples show the interaction between High-Level and Low-Level modules to achieve realistic simulations with dynamic changes in the environment geometry.

A shown in FIG. 14, on the 2D view the red rectangle of influence for one of the agents (affects agent avoidance forces) can be observed, the agents that affect the perceived density (with red points in the center of each agent), the avoidance forces with obstacles and walls in cyan, the avoidance forces with other agents in dark blue, and the stopping rules represented by circles of the same color as the agent waiting. The vector in the same color as the agent indicates the velocity direction.

### Computer Environment

FIG. 15 shows an illustrative embodiment of a general purpose computer system 150 on which the system described herein may operate. Components of computer 150 may include, but are not limited to, a processing unit 152, a system memory 153, and a system bus 154 that couples various system components including the system memory to the processing unit 152. The system bus 154 may be any of several types of bus structures including a memory bus or memory controller, a peripheral bus, and a local bus using any of a variety of bus architectures.

Processing unit 152 may be one or more general processors, digital signal processors, application specific integrated circuits, field programmable gate arrays, servers, networks, digital circuits, analog circuits, combinations thereof, or other now known or later developed devices for analyzing and processing data, and may implement a software program, such as code generated manually (i.e., programmed).

Computer 150 typically includes a variety of computer readable media, which can be any available media that can be accessed by computer 150, such as computer storage media and communication media. Computer storage media includes both volatile and nonvolatile, removable and non-removable media implemented in any method or technology for storage of information such as computer readable instructions, data structures, program modules or other data, and further includes, but is not limited to, RAM, ROM, EEPROM, flash memory or other memory technology, CDROM, digital versatile disks (DVD) or other optical disk storage, magnetic storage devices such as cassettes, tapes and disks, or any other medium that can be used to store the desired information and that can be accessed by computer 150. Communication media typically embodies computer readable instructions, data structures, program modules or other data in a modulated data signal, such as a carrier wave or other transport mechanism, and includes any information delivery media.

The system memory 153 may include computer storage media in the form of volatile and/or nonvolatile memory, such as read only memory (ROM) and/or random access memory (RAM). A basic input/output system (BIOS), containing the basic routines that help to transfer information between elements within computer 150, such as during start-up, may be stored in memory 153. Memory 153 typically also contains data and/or program modules that are immediately accessible to and/or presently being operated on by processing unit 152. By way of example, and not limitation, memory 153 may also include an operating system, application programs, other program modules, and program data. Computer 150 could also include a hard disk drive, magnetic disk drive and/or an optical disk drive that reads from or writes to suitable removable, nonvolatile media, such as a disk drive, CD-ROM, magnetic tape cassettes, flash memory cards, digital versatile disks, digital video tape, solid state RAM, solid state ROM and the like. A hard disk drive is typically connected to the system bus 154 a through a non-removable memory interface, and a magnetic disk drive or optical disk drive is typically connected to the system bus 154 by a removable memory interface.

Computer system 150 may include an input device 155 configured to allow a user to interact with any of the components thereof. The input device 155 may be a number pad, a keyboard, or a cursor control device, such as a mouse, joystick, touch screen display, microphone, remote control or any other device operative to interact with the system 600.

Computer system 150 may further include a display unit 156, such as a liquid crystal display (LCD), an organic light emitting diode (OLED), a flat panel display, a solid state display, a cathode ray tube (CRT), a projector, a printer or other now known or later developed display device for outputting determined information. The display 156 may act as an interface for the user to view the displayed simulation

Computer system 150 may operate as a stand alone device or may be connected, e.g., using a network or distributed environment, to other computer systems or peripheral devices, such as remote computer 157, which may in turn have media capabilities similar to or different from device 150. The remote computer 157 may be a personal computer, a server, a router, a network PC, a peer device or other common network node, or any other remote media consumption or transmission device, and may include any or all of the elements described above relative to the computer 150. The logical connections depicted in FIG. 15 include a network 158, such local area network (LAN) or a wide area network (WAN), and may also include network interface 159, such as physical connections such as buses, interfaces, modems or adapters, or wireless connections, all of which are well known in the art.

The functions and formulae described herein can be implemented by either special purpose hardware-based computer systems which perform the specified functions or steps, or suitable combinations of special purpose hardware and computer instructions. These functions and formulae may be loaded onto a general purpose computer, special purpose computer, or other programmable data processing apparatus to produce a machine, such that the instructions that execute on the computer or other programmable data processing apparatus create means for implementing the functions specified herein. These computer program instructions may also be stored in a computer-readable memory that can direct a computer or other programmable data processing apparatus to function in a particular manner, such that the instructions stored in the computer-readable memory produce an article of manufacture including instruction means which implement the function specified herein. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified herein.

A number of simulations have been presented that show HiDAC's visual output, and described methods for achieving many goals that enable realistic simulation of high-density crowds:

| Goal | Method |
|---|---|
| Fast perception of | Influence rectangles, distances, angles and directions of |
| environment | movement are used to prioritize obstacles. |
| Eliminate shaking | Apply stopping rules to forces model. |
| behavior | |
| Natural bi-directional | Variable length influence rectangles and different ‘right’ |
| flow | preferences. |
| Queuing behavior | Influence discs triggering waiting behavior based on agent |
| | direction. |
| Pushing behavior | Collision response based on variable ‘personal space |
| | thresholds’. |
| Falling agents becoming | Apply tangential forces for obstacle avoidance but not |
| new obstacles | repulsion forces. |
| Panic propagation | Modify agent behavior based on personality and perception of |
| | other agents' level of panic. |
| Crowd impatience | Dynamically modifying route selection based on |
| | environmental changes. |

Simulation tests were run on a 2.99 GHz Intel Xeon with 2 GB of RAM measuring frame rates both for simulation only and for simulation and 3D rendering. When doing only simulation, HiDAC can handle up to 1800 agents with a frame rate of 25 Hz. Simulation and 3D rendering using an NVIDIA Quadro FX 3400/4400 graphics system can achieve 25 frames/second (not using GPU rendering) for up to 600 simple 3D virtual human figures (“crayon figures”) each with about 100 vertices. For the frame rate tests, a large complex environment with 85 rooms and 53,448 vertices overall was used.

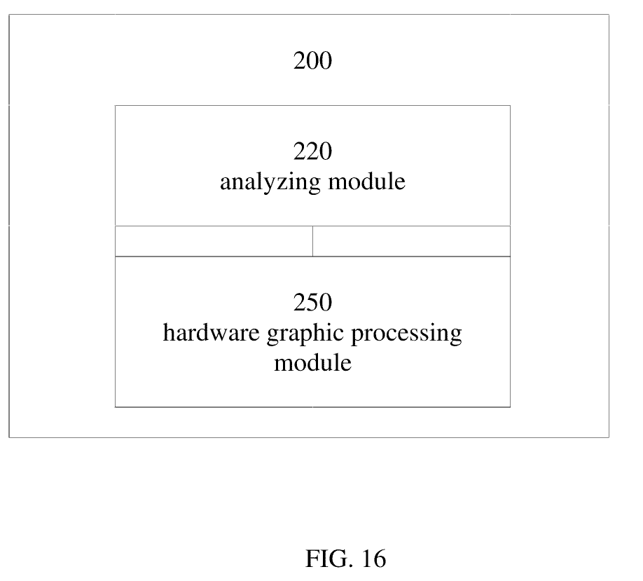

FIG. 16 illustrates system 200 for displaying behavior of a high density autonomous crowd in an environment on a display, according to an embodiment of the invention. It is noted that according to different embodiments of the invention, system 200 may include components of system 150, and vice versa, and that according to different embodiments of the invention, system 200 may implement functionalities of system 150, and vice versa.

System 200 includes at least analyzing module 220 and hardware graphic processing module 250.

Analyzing module 220 is capable at least of simulating a behavior of a plurality of the autonomous agents of the high density autonomous crowd in a representation of the dynamic environment; wherein the simulating is responsive to at least one characteristic of a each autonomous agent of a plurality of autonomous agents of the high density autonomous crowd; wherein the at least one characteristic is selected from a group consisting of a physiological characteristic and a behavior characteristic.

Hardware graphic processing module 250 is capable at least of displaying the plurality of autonomous agents in the dynamic environment.

According to an embodiment of the invention, the predetermined environment is a dynamically changing virtual environment.

According to an embodiment of the invention, analyzing module 220 is further capable of simulating changes on a dynamically changing virtual environment that includes at least one of building stairwells, doors, windows, obstacles, stadium exits or entrances, theaters exits, theaters entrances, streets, floor plans, airplane doors.

According to an embodiment of the invention, analyzing module 220 is further capable of simulating changes on the environment dynamically changes doors, entrances or exits between open and closed, or hazards blocking paths or their combination.

According to an embodiment of the invention, analyzing module 220 is further capable of indicating a relative position of each of a plurality of autonomous agents, and of assembling said high density autonomous crowd prior to the indicating.

According to an embodiment of the invention, the high density autonomous crowd includes at least four autonomous agents per square meter of predetermined environment.

According to an embodiment of the invention, the behavior includes at least one out line forming, panic onset, navigation, locomotion, communication between agents, decision-making, collision avoidance, pushing, impatience, training, learning features of the environment, leadership, orientation skills.

According to an embodiment of the invention, analyzing module 220 is further capable of applying a parameterized social forces model for the simulating.

According to an embodiment of the invention, analyzing module 220 is further capable of simulating a behavior of each autonomous agent in response to at least one predetermined psychological model variable.

According to an embodiment of the invention, analyzing module 220 is further capable of performing at least one out of a high level behavior simulating and a low level behavior simulating.

According to an embodiment of the invention, at least one of the high level behavior and the low level behavior is driven by a psychological model.

According to an embodiment of the invention, analyzing module 220 is further capable of simulating at least one of navigation, learning, communication between agents, and decision-making for the high level behavior simulating.

According to an embodiment of the invention, analyzing module 220 is further capable of simulating at least one out of collision avoidance, locomotion in bounded space, perception, speeds, personal space, densities, angles, reactive behaviors for collision detection, avoidance and response for the low level behavior simulating.

According to an embodiment of the invention, analyzing module 220 is further capable of performing high level behavior simulation in response to a psychological state variable and an agent personality.

According to an embodiment of the invention, the psychological state variable includes at least one out of panic, impatience, leader versus follower, trained versus untrained, communication, probability of suffering panic, current state of panic, probability of propagating panic, probability of falling, pushing thresholds, right preference, and avoidance intensity.

According to an embodiment of the invention, analyzing module 220 is further capable of performing low level behavior simulation in response to a variable affected by changes in the psychological state.

According to an embodiment of the invention, analyzing module 220 is further capable of receiving and incorporating changes to psychological or behavior characteristics and state while simulating.

According to an embodiment of the invention, analyzing module 220 is further capable of performing low level behavior simulation in response to at least one of speed, fall probability, pushing thresholds, orientation skills, queuing behavior, impatience, avoidance behavior.

According to an embodiment of the invention, analyzing module is further capable of adjusting autonomous agent locomotion in bounded space responsive to a plurality of predetermined factors.

According to an embodiment of the invention, the factor affecting autonomous locomotion in bounded space is distance, areas of influence, relative angles, relative directions, perceived density or their combination.

According to an embodiment of the invention, analyzing module 220 is further capable of simulating dynamic changes in the environment include that include at least one out of locking/unlocking entrances or exits, bottlenecks and hazards blocking paths.

According to an embodiment of the invention, hardware graphic processing module 250 is further configured of displaying results of the simulation on a display.

According to an embodiment of the invention, analyzing module 220 is further capable of applying at least one stopping rule to forces that affect a movement of an autonomous agent.

According to an embodiment of the invention, analyzing module 220 is further capable of applying at least one stopping rule to forces that affect a movement of an autonomous agent by setting a period between consecutive simulated movements of the autonomous agent.

According to an embodiment of the invention, analyzing module 220 is further capable of applying at least one stopping rule to forces that affect a movement of an autonomous agent by setting a random period between consecutive simulated movements of the autonomous agent.

According to an embodiment of the invention, analyzing module 220 is further capable of defining an influence region for an autonomous agent.

According to an embodiment of the invention, analyzing module 220 is further capable of triggering a waiting behavior autonomous agent in response to the influence region.

According to an embodiment of the invention, analyzing module 220 is further capable of defining a variable length influence regions for an autonomous agent.

According to an embodiment of the invention, analyzing module 220 is further capable of simulating a collision response of an autonomous agent in response to at least one personal space threshold.

According to an embodiment of the invention, analyzing module 220 is further capable of applying a tangential force for obstacle avoidance without applying a repulsion force, for the simulating.

According to an embodiment of the invention, analyzing module 220 is further capable of modifying a behavior of an autonomous agent in response to a personality of the autonomous agent and a perception of a level of panic of at least one other autonomous agent.

According to an embodiment of the invention, analyzing module 220 is further capable of simulating an impatient crowd by dynamical modifying route selection in response to at least one environmental change.

According to an embodiment of the invention, analyzing module 220 is further capable of simulating a movement of an autonomous agent in response to a desired attractor, while avoiding walls, obstacles and other autonomous agents while and trying to keep a previous direction of movement of the autonomous agent to avoid abrupt changes in its trajectory.

According to an embodiment of the invention, analyzing module 220 is further capable of simulating a movement of an autonomous agent in response to forces representing a desired attractor, walls, obstacles, other autonomous agents, previous direction of movement and weights assigned to the forces; wherein at least one weight is determined by at least one rule out of a psychological rule and a geometrical rule.

According to an embodiment of the invention, analyzing module 220 is further capable of exchanging information between a high level behavior module and a low level behavior module.

According to an embodiment of the invention, analyzing module 220 is further capable of implementing a receiving, by a high level behavior module, information about at least one of a bottleneck and a door change perceived by an autonomous agent; deciding by the high level behavior module, a next attractor and send next attractor information to a low level behavior module.

According to an embodiment of the invention, hardware graphic processing module 250 is further capable of indicating a relative position of each of a plurality of autonomous agents on the representation of the predetermined environment

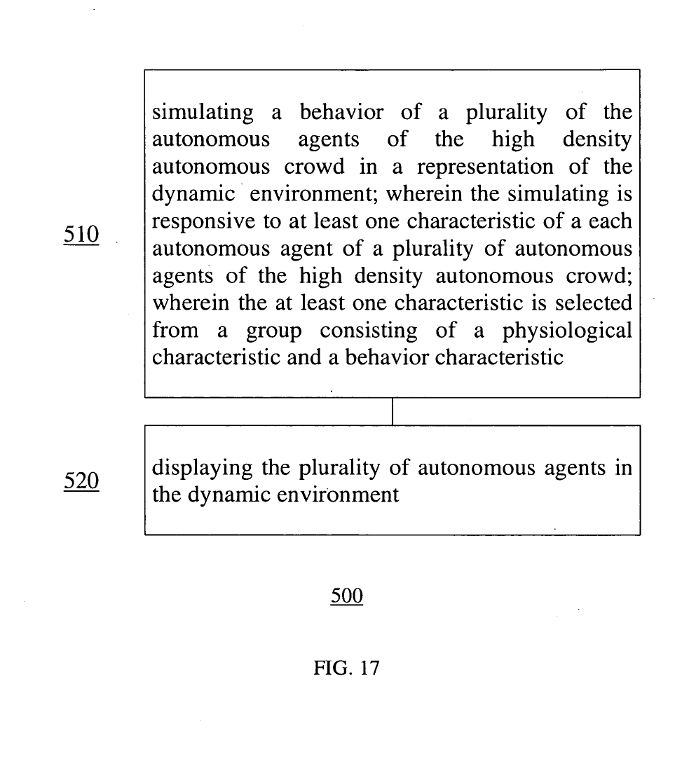

FIG. 17 illustrates method 500 for displaying behavior of a high density autonomous crowd in an environment on a display, according to an embodiment of the invention. It is noted that according to an embodiment of the invention, method 500 may be carried out by system 200, but this is not necessarily so.

Method 500 conveniently starts with stage 510 of simulating a behavior of a plurality of the autonomous agents of the high density autonomous crowd in a representation of the dynamic environment; wherein the simulating is responsive to at least one characteristic of a each autonomous agent of a plurality of autonomous agents of the high density autonomous crowd; wherein the at least one characteristic is selected from a group consisting of a physiological characteristic and a behavior characteristic.

Stage 510 is followed by stage 520 of displaying the plurality of autonomous agents in the dynamic environment.

According to an embodiment of the invention, the predetermined environment is a dynamically changing virtual environment.

According to an embodiment of the invention, the simulating changes on a dynamically changing virtual environment that includes at least one of building stairwells, doors, windows, obstacles, stadium exits or entrances, theaters exits, theaters entrances, streets, floor plans, airplane doors.

According to an embodiment of the invention, the simulating changes on the environment dynamically changes doors, entrances or exits between open and closed, or hazards blocking paths or their combination.

According to an embodiment of the invention, method 500 further includes a stage of indicating a relative position of each of a plurality of autonomous agents, which is preceded by a stage of assembling said high density autonomous crowd.

According to an embodiment of the invention, the high density autonomous crowd includes at least four autonomous agents per square meter of predetermined environment.

According to an embodiment of the invention, the behavior includes at least one out of line forming, panic onset, navigation, locomotion, communication between agents, decision-making, collision avoidance, pushing, impatience, training, learning features of the environment, leadership, orientation skills.

According to an embodiment of the invention, the simulating includes applying a parameterized social forces model.

According to an embodiment of the invention, method 500 includes simulating a behavior of each autonomous agent in response to at least one predetermined psychological model variable. In another embodiment the method includes the acceptance and response to a dynamic change.

According to an embodiment of the invention, method 500 includes performing at least one out of a high level behavior simulating and a low level behavior simulating.

According to an embodiment of the invention, at least one of the high level behavior and the low level behavior is driven by a psychological model.

According to an embodiment of the invention, the high level behavior simulating includes simulating at least one of navigation, learning, communication between agents, and decision-making.

According to an embodiment of the invention, the low level behavior simulating includes simulating at least one out of collision avoidance, locomotion in bounded space, perception, speeds, personal space, densities, angles, reactive behaviors for collision detection, avoidance and response.

According to an embodiment of the invention, method 500 includes performing high level behavior simulation in response to a psychological state variable and an agent personality.

According to an embodiment of the invention, the psychological state variable includes at least one out of panic, impatience, leader versus follower, trained versus untrained, communication, probability of suffering panic, current state of panic, probability of propagating panic, probability of falling, pushing thresholds, right preference, and avoidance intensity.

According to an embodiment of the invention, method 500 includes performing low level behavior simulation in response to a variable affected by changes in the psychological state.

According to an embodiment of the invention, method 500 includes performing low level behavior simulation in response to at least one of speed, fall probability, pushing thresholds, orientation skills, queuing behavior, impatience, avoidance behavior.

According to an embodiment of the invention, method 500 includes adjusting autonomous agent locomotion in a bounded space in response to a plurality of predetermined factors.

According to an embodiment of the invention, the factor affecting autonomous locomotion in bounded space is distance, areas of influence, relative angles, relative directions, perceived density or their combination.

According to an embodiment of the invention, method 500 includes simulating dynamic changes in the environment include that include at least one out of locking/unlocking entrances or exits, bottlenecks and hazards blocking paths.

According to an embodiment of the invention, method 500 includes displaying results of the simulation on a display.

According to an embodiment of the invention, the simulating is responsive to an applying of at least one stopping rule to forces that affect a movement of an autonomous agent.

According to an embodiment of the invention, the simulating is responsive to an applying of at least one stopping rule to forces that affect a movement of an autonomous agent by setting a period between consecutive simulated movements of the autonomous agent.

According to an embodiment of the invention, the simulating is responsive to an applying of at least one stopping rule to forces that affect a movement of an autonomous agent by setting a random period between consecutive simulated movements of the autonomous agent.

According to an embodiment of the invention, method 500 includes defining a variable length influence region for an autonomous agent.

According to an embodiment of the invention, method 500 includes triggering a waiting behavior autonomous agent in response to the influence region.

According to an embodiment of the invention, method 500 includes defining a variable length influence region for an autonomous agent.

According to an embodiment of the invention, the simulating includes simulating a collision response of an autonomous agent in response to at least one personal space threshold.

According to an embodiment of the invention, the simulating includes applying a tangential force for obstacle avoidance without applying a repulsion force.

According to an embodiment of the invention, the simulating includes modifying a behavior of an autonomous agent in response to a personality of the autonomous agent and a perception of a level of panic of at least one other autonomous agent.

According to an embodiment of the invention, the simulating includes simulating an impatient crowd by dynamically modifying route selection in response to at least one environmental change.

According to an embodiment of the invention, method 500 includes simulating a movement of an autonomous agent in response to a desired attractor, while avoiding walls, obstacles and other autonomous agents while and trying to keep a previous direction of movement of the autonomous agent to avoid abrupt changes in its trajectory.

According to an embodiment of the invention, method 500 includes simulating a movement of an autonomous agent in response to forces representing a desired attractor, walls, obstacles, other autonomous agents, previous direction of movement and weights assigned to the forces; wherein at least one weight is determined by at least one rule out of a psychological rule and a geometrical rule.

According to an embodiment of the invention, simulating includes exchanging information between a high level behavior module and a low level behavior module.

According to an embodiment of the invention, the simulating includes receiving, by a high level behavior module, information about at least one of a bottleneck and a door change perceived by an autonomous agent; deciding by the high level behavior module, next attractor and send next attractor information to a low level behavior module.

According to an embodiment of the invention, method 500 includes indicating a relative position of each of a plurality of autonomous agents on the representation of the predetermined environment

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

What is claimed is:

1. A method for displaying behavior of a high density autonomous crowd in a environment on a display, comprising the steps of:
simulating a behavior of a plurality of the autonomous agents of the high density autonomous crowd in a representation of the dynamic environment; wherein the simulating is responsive to at least one characteristic of each autonomous agent of a plurality of autonomous agents of the high density autonomous crowd; wherein at least one characteristic is selected from a group consisting of a physiological characteristic and a behavior characteristic; and displaying the plurality of autonomous agents in the dynamic environment.

2. The method of claim 1, whereby the simulating comprises applying a parameterized social forces model.

3. The method of claim 2, comprising simulating a behavior of each autonomous agent in response to at least one predetermined psychological model variable.

4. The method of claim 3, comprising performing at least one out of a high level behavior simulating and a low level behavior simulating.

5. The method according to claim 4 comprising wherein at least one of the high level behavior and the low level behavior is driven by a psychological model.

6. The method of claim 4, whereby the high level behavior simulating comprises simulating at least one of navigation, learning, communication between agents, and decision-making.

7. The method of claim 4, comprising performing high level behavior simulation in response to a psychological state variable and an agent personality.

8. The method of claim 5, whereby the psychological state variable comprises at least one out of panic, impatience, leader versus follower, trained versus untrained, communication, probability of suffering panic, current state of panic, probability of propagating panic, probability of falling, pushing thresholds, right preference, and avoidance intensity.

9. The method of claim 4 comprising performing low level behavior simulation in response to at least one of speed, fall probability, pushing thresholds, orientation skills, queuing behavior, impatience, avoidance behavior.

10. The method according to claim 1 wherein the simulating is responsive to an applying of at least one stopping rule to forces that affect a movement of an autonomous agent.

11. The method according to claim 1 wherein the simulating is responsive to an applying of at least one stopping rule to forces that affects a movement of an autonomous agent by setting a period between consecutive simulated movements of the autonomous agent.

12. The method according to claim 1 wherein the simulating is responsive to an applying of at least one stopping rule to forces that affect a movement of an autonomous agent by setting a random period between consecutive simulated movements of the autonomous agent.

13. The method according to claim 1 comprising defining an influence region for an autonomous agent.

14. The method according to claim 13 comprising triggering a waiting behavior autonomous agent in response to the influence region.

15. The method according to claim 1 comprising defining a variable length influence region for an autonomous agent.

16. The method according to claim 1 wherein the simulating comprises simulating a collision response of an autonomous agent in response to at least one personal space threshold.

17. The method according to claim 1 wherein the simulating comprises applying a tangential force for obstacle avoidance without applying a repulsion force.

18. The method according to claim 1 wherein the simulating comprises simulating an impatient crowd by dynamically modifying route selection in response to at least one environmental change.

19. The method according to claim 1 comprising simulating a movement of an autonomous agent in response to a desired attractor, while avoiding walls, obstacles and other autonomous agents while and trying to keep a previous direction of movement of the autonomous agent to avoid abrupt changes in its trajectory.

20. The method according to claim 1 comprising simulating a movement of an autonomous agent in response to forces representing a desired attractor, walls, obstacles, other autonomous agents, previous direction of movement and weights assigned to the forces; wherein at least one weight is determined by at least one rule out of a psychological rule and a geometrical rule.

21. The method according to claim 1 wherein the simulating comprises receiving, by a high level behavior module, information about at least one of a bottleneck and a door change perceived by an autonomous agent; deciding by the high level behavior module, a next attractor and send next attractor information to a low level behavior module.

22. A system for displaying behavior of a high density autonomous crowd in a environment on a display, the system comprising:
an analyzing module capable of simulating a behavior of a plurality of the autonomous agents of the high density autonomous crowd in a representation of the dynamic environment; wherein the simulating is responsive to at least one characteristic of each autonomous agent of a plurality of autonomous agents of the high density autonomous crowd; wherein at least one characteristic is selected from a group consisting of a physiological characteristic and a behavior characteristic; and
a hardware graphic processing module capable of displaying the plurality of autonomous agents in the dynamic environment.

23. The system according to claim 22, wherein the analyzing module is further capable of applying a parameterized social forces model for the simulating.

24. The system according to claim 22, wherein the analyzing module is further capable of performing at least one out of a high level behavior simulating and a low level behavior simulating.

25. The system according to claim 22 wherein at least one of the high level behavior and the low level behavior is driven by a psychological model.

26. The system according to claim 22 wherein the analyzing module is further capable of performing high level behavior simulation in response to a psychological state variable and an agent personality.

27. The system according to claim 22 wherein the analyzing module is further capable of accepting and responding to change in any of the variables.

28. The system according to claim 22 wherein the analyzing module is further capable of performing low level behavior simulation in response to a variable affected by changes in the psychological state.

29. The system according to claim 22 wherein the analyzing module is further capable of applying at least one stopping rule to forces that affect a movement of an autonomous agent.

30. The system according to claim 22 wherein the analyzing module is further capable of applying at least one stopping rule to forces that affect a movement of an autonomous agent by setting a period between consecutive simulated movements of the autonomous agent.

31. A system for simulating individual agents in a high density autonomous crowd, comprising:
a hardware graphic processing module enabling representation of simulation of individual agents in the high density autonomous crowd; and
an analyzing module capable of modeling motion of an autonomous agent in the high density autonomous crowd.
